(19) United States
(12) Patent Application Publication
(10) Pub. No.: US 2016/0268912 A1
(43) Pub. Date: Sep. 15, 2016

(54) SYSTEMS AND METHODS FOR CURRENT SENSING IN A POWER SYSTEM

(71) Applicant: Dell Products L.P., Round Rock, TX (US)

(72) Inventors: Lei Wang, Austin, TX (US); Mark A. Muccini, Georgetown, TX (US)

(21) Appl. No.: 14/656,289

(22) Filed: Mar. 12, 2015

(51) Int. Cl. H02M 3/335

(52) U.S. Cl. CPC H02M 3/33546; H02M 2001/0009

(57) ABSTRACT

A power system may include a subsystem, a capacitor coupled to the subsystem, a resistor coupled in series with the capacitor, and a controller. The subsystem may have an input for receiving a first direct current voltage and an output for generating a second direct current voltage and configured to convert the first direct current voltage into the second direct current voltage. The controller may be configured to receive a first signal indicative of a first current flowing in the capacitor and the resistor, receive a second signal indicative of one of a second current flowing into the input of the subsystem or out of the output of the subsystem, and based on the first signal and the second signal, determine one of an input current provided by a direct current source voltage coupled to the input or an output current delivered to a load coupled to the output.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include a power supply in order to convert power (e.g., provided by a public utility) to a desired voltage level and/or current level to power components of the information handling system. Oftentimes, it is desirable to collect telemetry data regarding the power supply, such as, for example, an amount of current being delivered by a power supply to components of an information handling system. For example, monitoring of power supply output current may be used to inform a controller of an information handling system for implementing a power sharing scheme among multiple power supply units, power supply redundancy schemes, over-current warnings, power throttling, and/or other uses.

One common approach to measuring output current is by using resistor shunts located at the output of a power supply unit. They may be located on either the positive or return rail and are often large in size to accommodate power dissipation. By measuring a voltage across a resistor shunt, and by knowing the resistive value of the shunt, the current may be derived from the voltage based on Ohm's law. It may be observed that shunts consume significant power and cause significant heat output. In addition, they are add financial burden to the manufacturing of an information handling system.

Another current sensing approach is to utilize a printed circuit board trace and its inherent resistive qualities to measure voltage across a portion of the trace and determine its current based on Ohm's law. However, such current sensing schemes may be undesirable, as low resistance of the trace may produce a low voltage, thus introducing a small signal-to-noise ratio. Such an approach may also be undesirable due to relatively large tolerances trace width, and the wide variability of resistance across various temperatures.

Yet another approach is to sense a voltage drop across an ORing metal-oxide-semiconductor field effect transistor (MOSFET) in the output path of a power system, as described in U.S. application Ser. No. 14/512,069 filed Oct. 10, 2014 by Ralph J. Johnson et al, and entitled “Systems and Methods for Measuring Power System Current Using OR-ing MOSFETs.” However, this approach suffers from component tolerances, thermal drift, and the difficulties in effectively calibrating in a high-volume production environment, thus resulting in higher degrees of complexity and cost. In addition, many power systems may not include an ORing MOSFET solution, which would prohibit the ability to use such an approach.

### SUMMARY

In accordance with the teachings of the present disclosure, the disadvantages and problems associated with current sensing in power systems may be reduced or eliminated.

In accordance with embodiments of the present disclosure, a power system may include a subsystem, a capacitor coupled to the subsystem, a resistor coupled in series with the capacitor, and a controller. The subsystem may have an input for receiving a first direct current voltage and an output for generating a second direct current voltage and configured to convert the first direct current voltage into the second direct current voltage. The controller may be configured to receive a first signal indicative of a first current flowing in the capacitor and the resistor, receive a second signal indicative of one of a second current flowing into the input of the subsystem or out of the output of the subsystem, and based on the first signal and the second signal, determine one of an input current provided by a direct current source voltage coupled to the input or an output current delivered to a load coupled to the output.

In accordance with these and other embodiments of the present disclosure, a method may include receiving a first signal indicative of a first current flowing in a capacitor and a resistor coupled in series with the capacitor. The method may also include receiving a second signal indicative of one of a second current flowing into an input of a subsystem or out of an output of the subsystem, wherein the input is for receiving a first direct current voltage and the output is for generating a second direct current voltage and wherein the subsystem is coupled to the capacitor and configured to convert the first direct current voltage into the second direct current voltage. The method may further include, based on the first signal and the second signal, determining one of an input current provided by a direct current source voltage coupled to the input or an output current delivered to a load coupled to the output.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example rectifier-based power system, in accordance with embodiments of the present disclosure;

FIG. 3 illustrates a block diagram of an example DC/DC converter stage of the power system depicted in FIG. 2, in accordance with embodiments of the present disclosure;

FIG. 4 illustrates a block diagram of an example voltage regulator-based power system, in accordance with embodiments of the present disclosure;

FIG. 5 illustrates a block diagram of an example voltage regulator of the power system depicted in FIG. 4, in accordance with embodiments of the present disclosure;

FIG. 6 illustrates a block diagram of another example voltage regulator-based power system, in accordance with embodiments of the present disclosure; and

FIG. 7 illustrates a block diagram of an example controller, in accordance with embodiments of the present disclosure.

### DETAILED DESCRIPTION

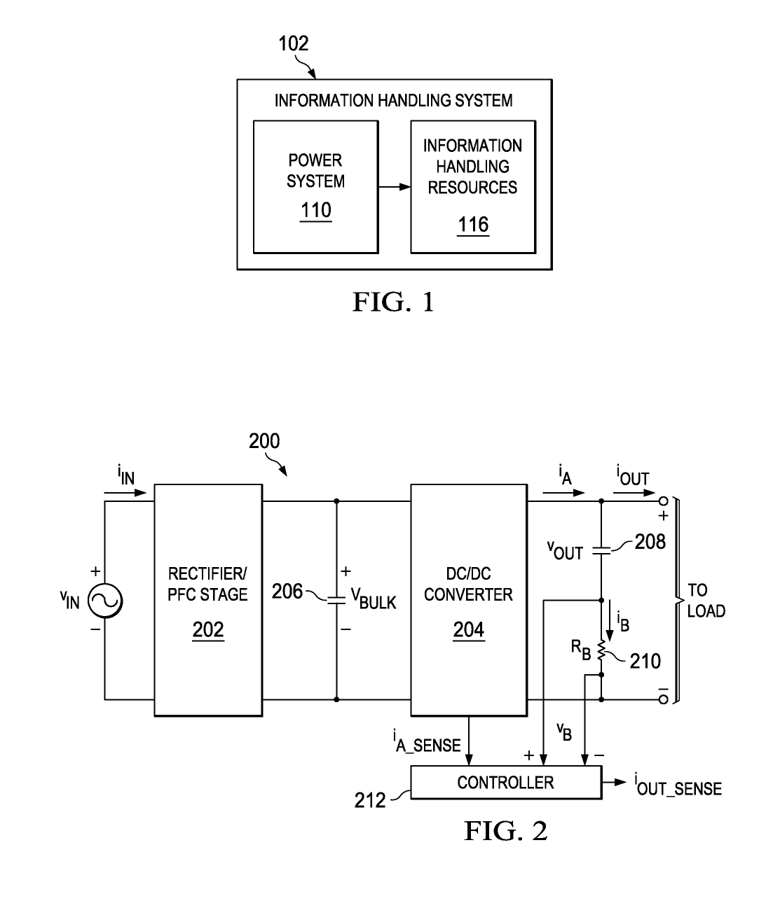

Preferred embodiments and their advantages are best understood by reference to FIGS. 1-7, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, power supplies, air movers (e.g., fans and blowers) and/or any other components and/or elements of an information handling system.

FIG. 1 illustrates a block diagram of an example of an information handling system 102. In some embodiments, information handling system 102 may comprise a server. In other embodiments, information handling system 102 may comprise networking equipment for facilitating communication over a communication network. In yet other embodiments, information handling system 102 may comprise a personal computer, such as a laptop, notebook, or desktop computer. In yet other embodiments, information handling system 102 may be a mobile device sized and shaped to be readily transported and carried on a person of a user of information handling system 102 (e.g., a smart phone, a tablet computing device, a handheld computing device, a personal digital assistant, etc.).

As shown in FIG. 1, information handling system 102 may include a power system 110 and one or more other information handling resources 116.

Generally speaking, power system 110 may include any system, device, or apparatus configured to supply electrical current to one or more information handling resources 116. In some embodiments, power system 110 may include a rectifier, such as the rectifier-based power system depicted in FIG. 2. In other embodiments, power system 110 may include a voltage regulator, such as the voltage regulator-based power system depicted in FIG. 4.

Generally speaking, information handling resources 116 may include any component system, device or apparatus of information handling system 102, including without limitation processors, buses, computer-readable media, input-output devices and/or interfaces, storage resources, network interfaces, motherboards, electro-mechanical devices (e.g., fans), displays, and/or power supplies.

FIG. 2 illustrates a block diagram of an example rectifier-based power system 200, in accordance with embodiments of the present disclosure. As shown in FIG. 2, rectifier-based power system 200 may include multiple converter stages: a rectifier/power factor correcting (PFC) stage 202, a DC/DC converter stage 204, a bulk capacitor 206 coupled between an output of rectifier PFC stage 202 and an input of DC/DC converter stage 204, an output capacitor 208 coupled to an output of DC/DC converter stage 204, a sense resistor 210 in series with output capacitor 208 and coupled to the output of DC/DC converter stage 204, and a controller 212. In some embodiments, the positions of output capacitor 208 and sense resistor 210 shown in FIG. 2 may be reversed.

Rectifier/PFC stage 202 may be configured to, based on an input current i_{IN}, a sinusoidal voltage source v_{IN}, and a bulk capacitor voltage V_{BULK}, shape the input current i_{IN} to have a sinusoidal waveform in-phase with the source voltage v_{IN} and to generate regulated DC bus voltage V_{BULK} on bulk capacitor 206. In some embodiments, rectifier/PFC stage 202 may be implemented as an AC/DC converter using a boost converter topology.

DC/DC converter stage 204 may convert bulk capacitor voltage V_{BULK} to a DC output voltage V_{OUT} on the series combination of output capacitor 208 and sense resistor 210 which may be provided to a load (e.g., to information handling resources 116 in order to power such information handling resources 116), which may generate a current i_{OUT} delivered to the load. In some embodiments, DC/DC converter stage 204 may be implemented as a resonant converter which converts a higher DC voltage (e.g., 400 V) into a lower DC voltage (e.g., 12 V). As shown in FIG. 2, DC/DC converter stage 204 may generate a pre-capacitor current i_{A} that charges output capacitor 208 and the load.

Sense resistor 210 may comprise any circuit element whose current i_{B} is related to the voltage v_{B} across such element in accordance with Ohm's law. In some embodiments, sense resistor 210 may comprise a bulk resistor or similar resistor formed on a printed circuit board having a nominal resistance R_{B}. In other embodiments, sense resistor 210 may comprise a metal-oxide-semiconductor field-effect transistor (MOSFET) with the sensed resistance R_{B} being the drain-to-source resistance of the MOSFET when the MOSFET is on.

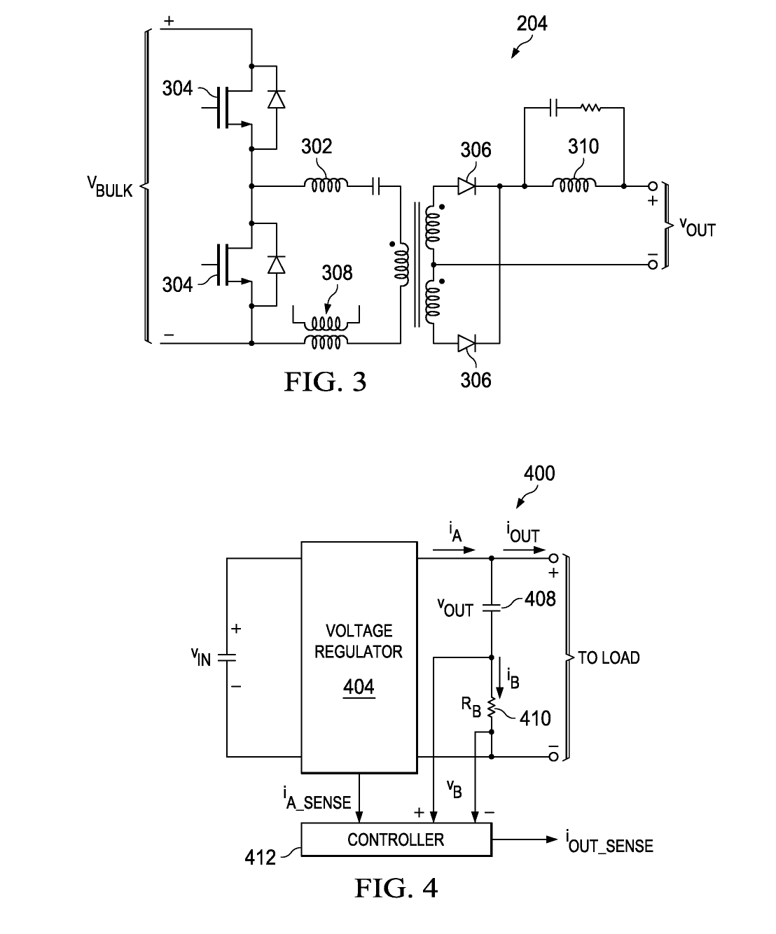

Controller 212 may be communicatively coupled to DC/DC converter 204 and sense resistor 210, and may comprise any system, device, or apparatus configured to sense a signal i_{A}_{_}_{SENSE} indicative of the pre-capacitor current i_{A} and a signal (e.g., sense resistor 210 voltage v_{B}) indicative of current i_{B} flowing through output capacitor 208 and sense resistor 210 and determine therefrom the output current i_{OUT} delivered to the load. Controller 212 may include, without limitation a microprocessor, microcontroller, digital signal processor (DSP), application specific integrated circuit (ASIC), or any other digital or analog circuitry configured to interpret and/or execute program instructions and/or process data. In some embodiments, controller 212 may interpret and/or execute program instructions (e.g., firmware) and/or process data stored in computer-readable media accessible to controller 212. Examples of signals i_{A}_{_}_{SENSE} indicative of the pre-capacitor current i_{A} are described in greater detail below in reference to FIG. 3. In operation, controller 212 may be able to, based on signal i_{A}_{_}_{SENSE} and current i_{B}, determine the output current i_{OUT} delivered to the load (e.g., by applying Kirchoff's current law: i_{OUT}=i_{A}−i_{B}). Having determined the output current i_{OUT}, controller 212 may produce a signal i_{OUT}_{_}_{SENSE} indicative of output current i_{OUT}. Greater detail regarding the structure and function of controller 212 may be described below with reference to FIG. 7.

FIG. 3 illustrates a block diagram of an example DC/DC converter stage 204, in accordance with embodiments of the present disclosure. Those of ordinary skill in the art may recognize example DC/DC converter stage 204 as an LLC resonant converter. Because the structure of the LLC resonant converter 204 depicted in FIG. 3 may be known by those of ordinary skill in the art, the structure and functionality of components of LLC resonant converter 204 are not described in detail, other than noting various techniques in which a signal i_{A}_{_}_{SENSE} indicative of the pre-capacitor current i_{A} may be extracted from LLC resonant converter 204. For example, in some embodiments, signal i_{A}_{_}_{SENSE} may be determined based on a current through a current sense transformer 308 of DC/DC converter stage 204 (in which case, to accurately reflect this pre-capacitor current, multiple samples in a switching cycle may need to be performed to filter out a magnetizing current of the main transformer of DC-DC converter 204). As another example, signal i_{A}_{_}_{SENSE} may be determined based on a sensed voltage across an output inductor 310 and the direct-current resistance of inductor 310. As a further example, signal i_{A}_{_}_{SENSE} may be determined based on a sensed voltage across one of switching MOSFETs 304 and the drain-to-source resistance across such MOSFET 304 when on. As yet another example, in embodiments in which diodes 306 are replaced with MOSFETs for synchronous rectification of DC-DC converter 204, signal i_{A}_{_}_{SENSE} may be determined based on a sensed voltage across one of such rectifying MOSFETs and the drain-to-source resistance across such MOSFET when on.

FIG. 4 illustrates a block diagram of an example voltage regulator-based power system 400, in accordance with embodiments of the present disclosure. As shown in FIG. 4, power system 400 may include a voltage regulator 404, an output capacitor 408, a sense resistor 410, and a controller 412. Voltage regulator 404 may boost or reduce a DC input voltage v_{IN} in order to generate a DC output voltage V_{OUT} on the series combination of output capacitor 408 and sense resistor 410, which may be provided to a load (e.g., to information handling resources 116 in order to power such information handling resources 116), which in turn may generate a current i_{OUT} delivered to the load. Thus, voltage regulator 404 may essentially operate as a DC/DC converter. In some embodiments, voltage regulator 404 may be implemented as a multi-phase voltage regulator with the ability to perform phase shedding. As shown in FIG. 4, voltage regulator 404 may generate a pre-capacitor current i_{A} that charges output capacitor 408 and the load.

Sense resistor 410 may comprise any circuit element whose current i_{B} is related to the voltage v_{B} across such element in accordance with Ohm's law. In some embodiments, sense resistor 410 may comprise a bulk resistor or similar resistor formed on a printed circuit board having a nominal resistance R_{B}. In other embodiments, sense resistor 410 may comprise a metal-oxide-semiconductor field-effect transistor (MOSFET) with the sensed resistance R_{B} being the drain-to-source resistance of the MOSFET when the MOSFET is on.

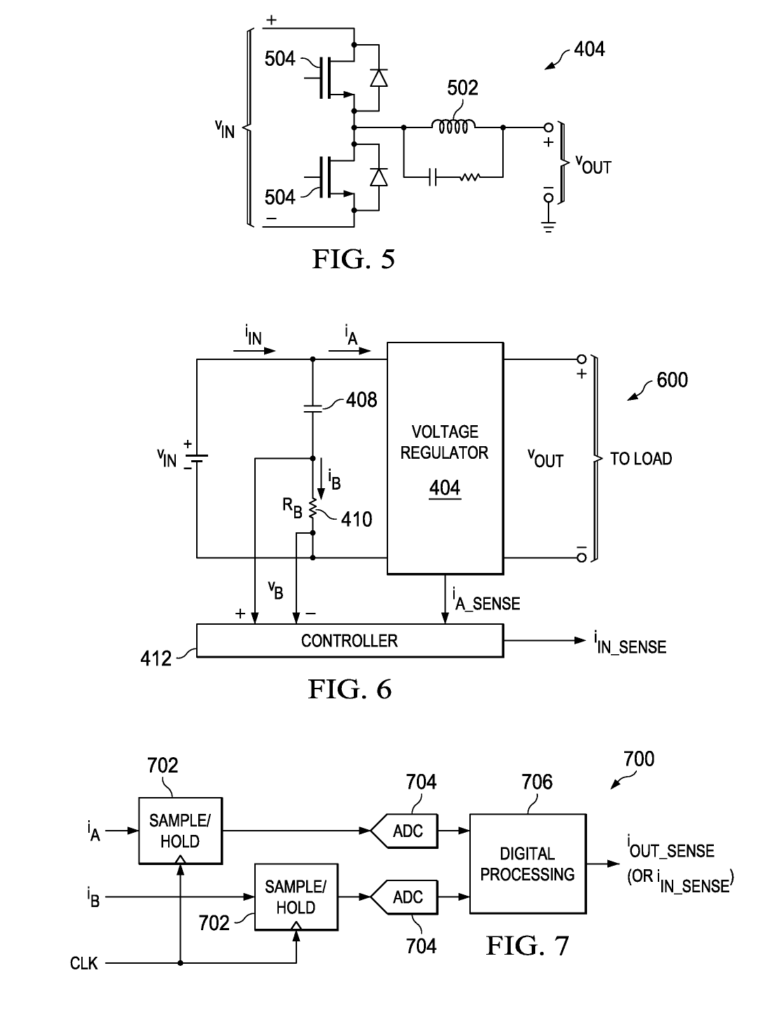

Controller 412 may be communicatively coupled to voltage regulator 404 and sense resistor 410, and may comprise any system, device, or apparatus configured to sense a signal i_{A}_{_}_{SENSE} indicative of the pre-capacitor current i_{A} and a signal (e.g., sense resistor 410 voltage v_{B}) indicative of current i_{B} flowing through output capacitor 408 and sense resistor 410 and determine therefrom the output current i_{OUT} delivered to the load. Controller 412 may include, without limitation a microprocessor, microcontroller, digital signal processor (DSP), application specific integrated circuit (ASIC), or any other digital or analog circuitry configured to interpret and/or execute program instructions and/or process data. In some embodiments, controller 212 may interpret and/or execute program instructions (e.g., firmware) and/or process data stored in computer-readable media accessible to controller 412. Examples of signals i_{A}_{_}_{SENSE} indicative of the pre-capacitor current i_{A} are described in greater detail below in reference to FIG. 5. In operation, controller 412 may be able to, based on signal i_{A}_{_}_{SENSE} and current i_{B}, determine the output current i_{OUT} delivered to the load (e.g., by applying Kirchoff's current law: i_{OUT}=i_{A}−i_{B}). Having determined the output current i_{OUT}, controller 412 may produce a signal i_{OUT}_{_}_{SENSE} indicative of output current i_{OUT}. Greater detail regarding the structure and function of controller 412 may be described below with reference to FIG. 7.

FIG. 5 illustrates a block diagram of an example voltage regulator 404 of the power system 400, in accordance with embodiments of the present disclosure. Those of ordinary skill in the art may recognize example voltage regulator 404 having a common-known topology. Because the structure of the voltage regulator 404 depicted in FIG. 5 may be known by those of ordinary skill in the art, the structure and functionality of components of voltage regulator 404 are not described in detail, other than noting various techniques in which a signal i_{A}_{_}_{SENSE} indicative of the pre-capacitor current i_{A} may be extracted from voltage regulator 404. For example, in some embodiments, signal i_{A}_{_}_{SENSE} may be determined based on a sensed voltage across inductor 502 and the direct-current resistance of inductor 502. As a further example, signal i_{A}_{_}_{SENSE} may be determined based on a sensed voltage across one of switching MOSFETs 504 and the drain-to-source resistance across such MOSFET 504 when on.

FIG. 6 illustrates a block diagram of an example voltage regulator-based power system 600, in accordance with embodiments of the present disclosure. Power system 600 is similar to power system 400, except that the series combination of capacitor 408 and sense resistor 410 is in parallel with input voltage v_{IN}. In such arrangement, controller 412 may use techniques similar to that described elsewhere in this disclosure to calculate an input current i_{IN} based on a post-capacitor current i_{A} flowing to voltage regulator 404 and current i_{B} through the series combination of capacitor 408 and sense resistor 410 (e.g., i_{IN}=i_{A}+i_{B}), and output a signal i_{IN}_{_}_{SENSE} indicative of input current i_{IN}. In some embodiments, the positions of output capacitor 208 and sense resistor 210 shown in FIG. 2 may be reversed.

FIG. 7 illustrates a block diagram of an example controller 700, in accordance with embodiments of the present disclosure. Controller 700 may be used to form all or a portion of controller 212 and controller 412 described above. As shown in FIG. 7, controller 700 may include two or more sample and hold circuits 702, two or more analog-to-digital converters (ADCs) 704, and a digital processing block 706. In operation, sample and hold circuits 702 may each synchronously sample currents i_{A} and i_{B} (or signals indicative of such currents). Each sampled current value may then be converted to the digital domain by ADCs 704. The digital values of both currents may then be delivered to digital processing block 706, which may calculate the output current i_{OUT} (or input current i_{IN} in embodiments similar to that of FIG. 6) and output a digital signal I_{OUT}_{_}_{SENSE} (or SENSE I_{IN}_{_}_{SENSE}) indicative of the calculated out (or input) current.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A power system comprising:
a subsystem having an input for receiving a first direct current voltage and an output for generating a second direct current voltage and configured to convert the first direct current voltage into the second direct current voltage;
a capacitor coupled to the subsystem;
a resistor coupled in series with the capacitor; and
a controller configured to:
receive a first signal indicative of a first current flowing in the capacitor and the resistor;
receive a second signal indicative of one of a second current flowing into the input of the subsystem or out of the output of the subsystem; and
based on the first signal and the second signal, determine one of an input current provided by a direct current source voltage coupled to the input or an output current delivered to a load coupled to the output.

2. The power system of claim 1, wherein the subsystem comprises a direct-current-to-direct-current converter stage.

3. The power system of claim 1, wherein the subsystem comprises a voltage regulator.

4. The power system of claim 1, wherein the resistor comprises a bulk resistor.

5. The power system of claim 1, wherein the resistor comprises a drain-to-source voltage of a field-effect transistor.

6. The power system of claim 1, wherein the second signal is indicative of one of a current sensed by a current sense transformer of the subsystem, a current flowing through an inductor of the subsystem, and a current flowing through a transistor of the subsystem.

7. The power system of claim 1, wherein the second signal is indicative of current flowing into the input of the subsystem and the controller determines the input current.

8. The power system of claim 1, wherein the second signal indicative of current flowing out of the output of the subsystem and the controller determines the output current.

9. The power system of claim 1, wherein the controller is further configured to synchronously sample the first signal and the second signal.

10. The power system of claim 9, wherein the controller is further configured to:
convert each of the sampled first signal and the sampled second signal into respective digital signals; and
based on such digital signals, determine the input current and the output current.

11. A method comprising:
receiving a first signal indicative of a first current flowing in a capacitor and a resistor coupled in series with the capacitor;
receiving a second signal indicative of one of a second current flowing into an input of a subsystem or out of an output of the subsystem, wherein the input is for receiving a first direct current voltage and the output is for generating a second direct current voltage and wherein the subsystem is coupled to the capacitor and configured to convert the first direct current voltage into the second direct current voltage; and
based on the first signal and the second signal, determining one of an input current provided by a direct current source voltage coupled to the input or an output current delivered to a load coupled to the output.

12. The method of claim 11, wherein the subsystem comprises a direct-current-to-direct-current converter stage.

13. The method of claim 11, wherein the subsystem comprises a voltage regulator.

14. The method of claim 11, wherein the resistor comprises a bulk resistor.

15. The method of claim 11, wherein the resistor comprises a drain-to-source voltage of a field-effect transistor.

16. The method of claim 11, wherein the second signal is indicative of a current sensed by a current sense transformer of the subsystem, a current flowing through an inductor of the subsystem, or a current flowing through a transistor of the subsystem.

17. The method of claim 11, wherein the second signal is indicative of current flowing into the input of the subsystem and the method comprises determining the input current.

18. The method of claim 11, wherein the second signal indicative of current flowing out of the output of the subsystem and the method comprises determining the output current.

19. The method of claim 11, further comprising synchronously sampling the first signal and the second signal.

20. The method of claim 19, further comprising:
converting each of the sampled first signal and the sampled second signal into respective digital signals; and
based on such digital signals, determining the input current and the output current.
